(19) United States
(12) Patent Application Publication
(10) Pub. No.: US 2025/0203520 A1
(43) Pub. Date: Jun. 19, 2025

(54) ENERGY HARVESTING DEVICE CONFIGURATION

(71) Applicant: QUALCOMM Incorporated, San Diego, CA (US)

(72) Inventors: Ahmed ELSHAFIE, San Diego, CA (US); Ahmed Attia ABOTABL, San Diego, CA (US); Seyedkianoush HOSSEINI, San Diego, CA (US); Alexandros MANOLAKOS, Athens (GR); Muhammad Sayed Khairy ABDELGHAFFAR, San Jose, CA (US); Wanshi CHEN, San Diego, CA (US); Yuchul KIM, San Diego, CA (US)

(21) Appl. No.: 18/838,951

(22) PCT Filed: Mar. 16, 2023
(86) PCT No.: PCT/US2023/064555

§ 371 Date: Aug. 15, 2024

(30) Foreign Application Priority Data
Apr. 26, 2022 (GR) 20220100345

(51) Int. Cl. H04W 52/02; H02J 50/00; H04W 72/40

(52) U.S. Cl. CPC H04W 52/0235; H02J 50/001; H04W 72/40

(57) ABSTRACT

Various aspects of the present disclosure generally relate to wireless communication. In some aspects, a user equipment (UE) may transmit an indication of an energy mode in which the UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE. The UE may operate according to a configuration associated with the energy mode based at least in part on transmitting the indication of the energy mode. Numerous other aspects are described.

### CROSS-REFERENCE TO RELATED APPLICATION

This Patent application claims priority to Greek patent application No. 20220100345, filed on Apr. 26, 2022, entitled “ENERGY HARVESTING DEVICE CONFIGURATION,” which is hereby expressly incorporated by reference herein.

### FIELD OF THE DISCLOSURE

Aspects of the present disclosure generally relate to wireless communication and to techniques and apparatuses for energy harvesting (EH) device configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of energy harvesting, in accordance with the present disclosure.

FIG. 4 is a diagram illustrating an example associated with EH device configuration, in accordance with the present disclosure.

FIGS. 5 and 6 are diagrams illustrating example processes associated with EH device configuration, in accordance with the present disclosure.

FIGS. 7 and 8 are diagrams of example apparatuses for wireless communication, in accordance with the present disclosure.

### SUMMARY

Some aspects described herein relate to a method of wireless communication performed by a UE. The method may include transmitting an indication of an energy mode in which the UE is to operate, where the energy mode indicates a type of energy harvesting to be performed by the UE and a level of engagement of the UE in association with performing the type of energy harvesting, and where the energy mode is one of a plurality of energy modes associated with a class of the UE. The method may include operating according to a configuration associated with the energy mode based at least in part on transmitting the indication of the energy mode.

Some aspects described herein relate to a method of wireless communication performed by a network entity. The method may include receiving an indication of an energy mode in which a UE is to operate, where the energy mode indicates a type of energy harvesting to be performed by the UE and a level of engagement of the UE in association with performing the type of energy harvesting, and where the energy mode is one of a plurality of energy modes associated with a class of the UE. The method may include operating according to a configuration associated with the energy mode based at least in part on receiving the indication of the energy mode.

Some aspects described herein relate to a UE for wireless communication. The UE may include a memory and one or more processors coupled to the memory. The one or more processors may be configured to transmit an indication of an energy mode in which the UE is to operate. The one or more processors may be configured to operate according to a configuration associated with the energy mode based at least in part on transmitting the indication of the energy mode.

Some aspects described herein relate to a network entity for wireless communication. The network entity may include a memory and one or more processors coupled to the memory. The one or more processors may be configured to receive an indication of an energy mode in which a UE is to operate. The one or more processors may be configured to operate according to a configuration associated with the energy mode based at least in part on receiving the indication of the energy mode.

Some aspects described herein relate to a non-transitory computer-readable medium that stores a set of instructions for wireless communication by a UE. The set of instructions, when executed by one or more processors of the UE, may cause the UE to transmit an indication of an energy mode in which the UE is to operate. The set of instructions, when executed by one or more processors of the UE, may cause the UE to operate according to a configuration associated with the energy mode based at least in part on transmitting the indication of the energy mode.

Some aspects described herein relate to a non-transitory computer-readable medium that stores a set of instructions for wireless communication by a network entity. The set of instructions, when executed by one or more processors of the network entity, may cause the network entity to receive an indication of an energy mode in which a UE is to operate. The set of instructions, when executed by one or more processors of the network entity, may cause the network entity to operate according to a configuration associated with the energy mode based at least in part on receiving the indication of the energy mode.

Some aspects described herein relate to an apparatus for wireless communication. The apparatus may include means for transmitting an indication of an energy mode in which the apparatus is to operate, where the energy mode indicates a type of energy harvesting to be performed by the apparatus and a level of engagement of the apparatus in association with performing the type of energy harvesting, and where the energy mode is one of a plurality of energy modes associated with a class of the apparatus. The apparatus may include means for operating according to a configuration associated with the energy mode based at least in part on transmitting the indication of the energy mode.

Some aspects described herein relate to an apparatus for wireless communication. The apparatus may include means for receiving an indication of an energy mode in which a UE is to operate, where the energy mode indicates a type of energy harvesting to be performed by the UE and a level of engagement of the UE in association with performing the type of energy harvesting, and where the energy mode is one of a plurality of energy modes associated with a class of the UE. The apparatus may include means for operating according to a configuration associated with the energy mode based at least in part on receiving the indication of the energy mode.

Aspects generally include a method, apparatus, system, computer program product, non-transitory computer-readable medium, user equipment, base station, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

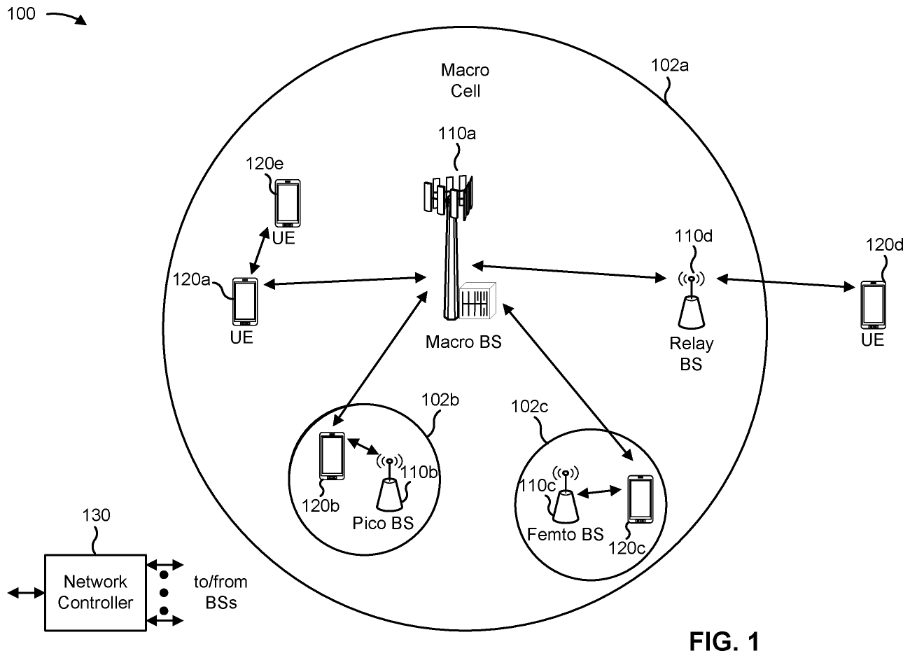

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

Deployment of communication systems, such as 5G New Radio (NR) systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit an indication of an energy mode in which the UE 120 is to operate, wherein the energy mode indicates a type of energy harvesting to be performed by the UE 120 and a level of engagement of the UE 120 in association with performing the type of energy harvesting, and wherein the energy mode is one of a plurality of energy modes associated with a class of the UE 120; and operate according to a configuration associated with the energy mode based at least in part on transmitting the indication of the energy mode. Additionally, or alternatively, the communication manager 140 may perform one or more other operations described herein.

In some aspects, a network entity, such as a base station 110, may include a communication manager 150. As described in more detail elsewhere herein, the communication manager 150 may receive an indication of an energy mode in which a UE 120 is to operate, wherein the energy mode indicates a type of energy harvesting to be performed by the UE 120 and a level of engagement of the UE 120 in association with performing the type of energy harvesting, and wherein the energy mode is one of a plurality of energy modes associated with a class of the UE 120; and operate according to a configuration associated with the energy mode based at least in part on receiving the indication of the energy mode. Additionally, or alternatively, the communication manager 150 may perform one or more other operations described herein.

As indicated above, FIG. 1 is provided as an example. Other examples may differ from what is described with regard to FIG. 1.

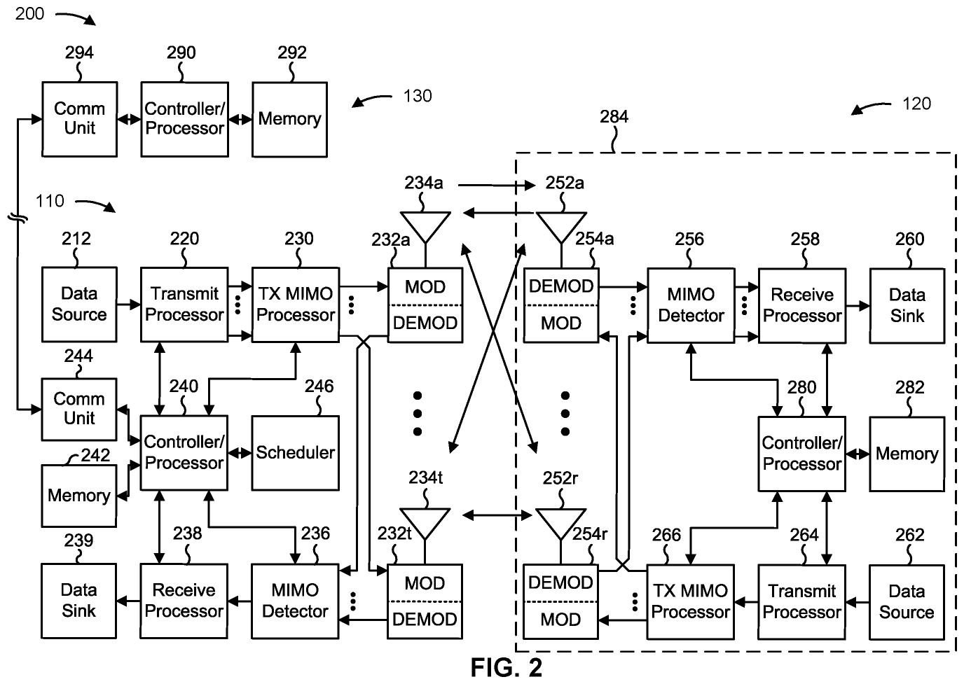

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

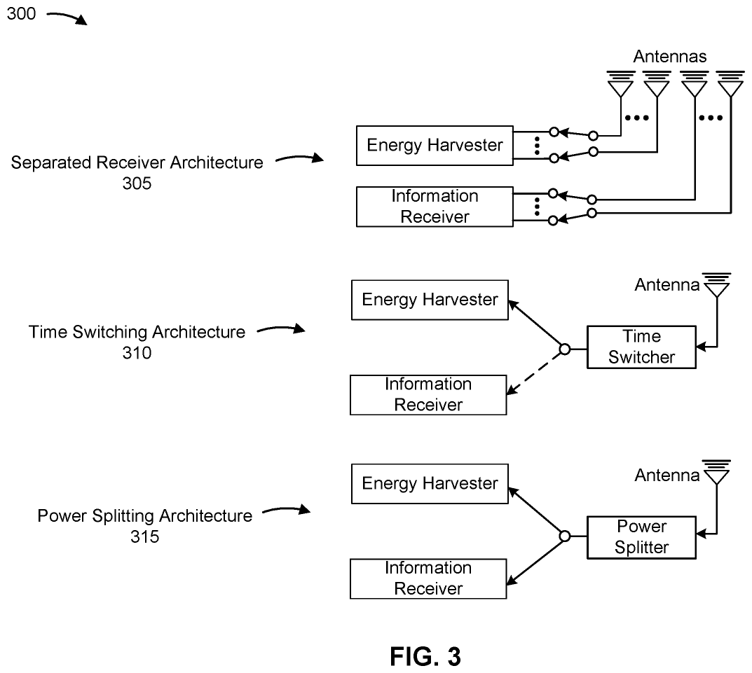

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-8).

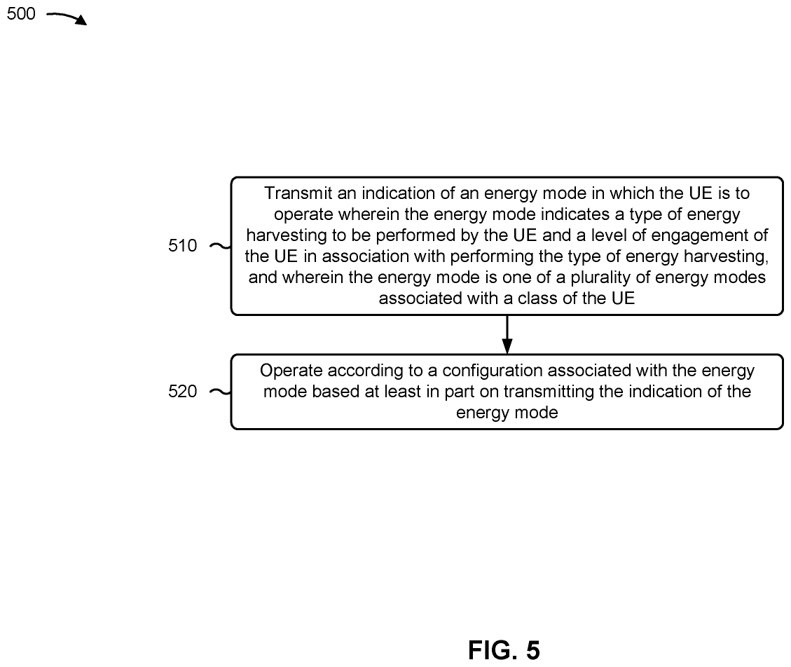

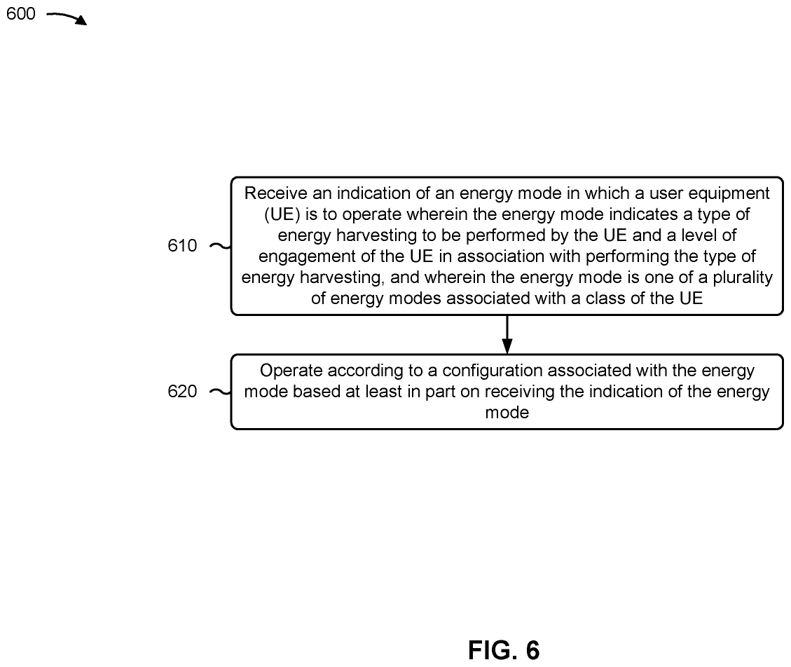

The controller/processor 240 of the base station 110, the controller/processor 280 of the UE 120, and/or any other component(s) of FIG. 2 may perform one or more techniques associated with EH device configuration, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting an indication of an energy mode in which the UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE; and/or means for operating according to a configuration associated with the energy mode based at least in part on transmitting the indication of the energy mode. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., the base station 110) includes means for receiving an indication of an energy mode in which a UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE; and/or means for operating according to a configuration associated with the energy mode based at least in part on receiving the indication of the energy mode. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of energy harvesting, in accordance with the present disclosure.

Energy harvesting (EH) includes obtaining energy from a source other than an on-device energy storage device (e.g., a battery or a capacitor, among other examples). EH may be used to supplement energy obtained from an on-device energy storage device and/or may provide charging to the on-device energy storage device. Devices that use EH (“energy harvesting devices” or “EH devices”) may have a low-capacity energy storage device (e.g., smart watch) or no energy storage device (e.g., zero power devices, IoT devices, wearables, or financial devices). EH may include converting RF energy transferred from another device. Harvesting RF energy may not provide sufficient energy to fully charge an energy storage device but may be used for performing tasks such as data decoding, operating filters, data reception, data encoding, data reception, and/or data transmission, among other examples. The EH device may accumulate harvested energy over time (e.g., in an on-device energy storage device) to use in a subsequent operation. EH may also be a part of self-sustainable networks, where an EH device in the network may communicate within the network using energy harvested from transmissions of other devices in the network.

As shown in FIG. 3, an EH device (e.g., an RF receiver or a UE 120, among other examples) may receive signals (e.g., radio signals carried on radio waves) from a donor device (e.g., a transmitting device, an RF transmitter, a charging device, a base station 110, or a donor UE 120, among other examples) and convert electromagnetic energy of the signals (e.g., using a rectenna comprising a dipole antenna with an RF diode) into direct current electricity for use by the EH device. The EH device may be a low power device or a zero power device, among other examples.

As shown by reference number 305, in some aspects, the EH device may use a separated receiver architecture, where a first set of antennas is configured to harvest energy, and a second set of antennas is configured to receive data. In this scenario, each set of antennas may be separately configured to receive signals at certain times, frequencies, and/or via one or more particular beams, such that all signals received by the first set of antennas are harvested for energy, and all signals received by the second set of antennas are processed and/or decoded to receive information or other communications.

As shown by reference number 310, in some aspects, the EH device may use a time-switching architecture to harvest energy. The time switching architecture may use one or more antennas to receive signals, and whether the signals are harvested for energy or processed to receive information depends on the time at which the EH device receives the signals. For example, one or more first time slots may be time slots during which received signals are sent to one or more EH components to harvest energy, and one or more second time slots may be time slots during which received signals are processed and decoded to receive information. In some aspects, the time slots may be pre-configured (e.g., by the EH device, the donor device, or another device).

As shown by reference number 315, in some aspects, the EH device may use a power splitting architecture to harvest energy. The power splitting architecture may use one or more antennas to receive signals, and the signals are handled by one or both of the EH and/or information receiving components according to an EH rate. For example, the EH device may be configured to use a first portion of received signals for EH and the remaining received signals for information receiving. In some aspects, the EH rate may be pre-configured (e.g., by the EH device, the donor device, or another device).

The EH device may receive signals for EH on certain resources (e.g., time, frequency, and/or spatial resources) and at a certain power level that results in a particular charging rate. Energy harvested by the EH device may be used and/or stored for later use. For example, in some aspects, the EH device may be powered directly by the harvested energy. In some aspects, the EH device may use an energy storage device, such as a battery, capacitor, and/or supercapacitor, to gather and store harvested energy for immediate and/or later use.

In some aspects, the EH device may implement one or more EH techniques in addition to or alternatively from the RF energy harvesting technique described above. For example, the EH device may in some cases implement EH through the use of solar cells (e.g., one or more devices capable of harvesting solar energy) or the use of vibration (e.g., one or more devices capable of harvesting energy from vibrations of the EH device), among other examples.

As indicated above, FIG. 3 is provided as an example. Other examples may differ from what is described with regard to FIG. 3.

An EH device may be capable of harvesting energy using one or more EH technologies, such as RF energy harvesting, solar energy harvesting, or vibration energy harvesting, among other examples. An EH device may include one or more hardware circuits or processing units for each of these EH technologies, the operation of which could impact wireless communication (e.g., NR communications). As a result of the impact of EH on wireless communication, the EH device may apply timeline and processing time restrictions in association with employing one or more of these EH technologies. However, to support efficient and reliable communication in a wireless network, some amount of configuration and coordination between the EH device and a network entity (e.g., a base station) needs to be provided.

Some aspects described herein provide techniques and apparatuses for EH device configuration. In some aspects, a UE (e.g., an EH UE) may transmit an indication of an energy mode in which the UE is to operate. The energy mode may indicate a type of energy harvesting to be performed by the UE and a level of engagement of the UE in association with performing the type of energy harvesting, and may be one of a plurality of energy modes associated with a class of the UE. The UE may then operate according to a configuration associated with the energy mode based at least in part on transmitting the indication of the energy mode. Additional details are described below.

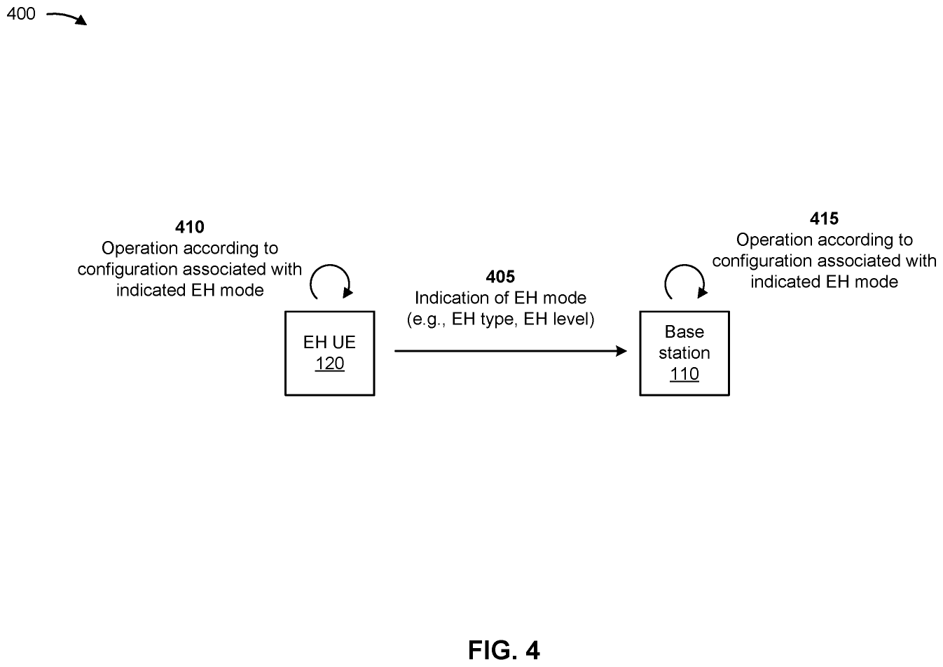

FIG. 4 is a diagram illustrating an example 400 associated with EH device configuration, in accordance with the present disclosure. As shown in FIG. 4, example 400 includes communication between a network entity (e.g., a base station 110) and a UE (e.g., a UE 120). In some aspects, the base station 110 and the UE 120 may be included in a wireless network, such as wireless network 100. In some aspects, the base station 110 and the UE 120 may communicate via a wireless access link, which may include an uplink and a downlink.

In example 400, the UE 120 is an EH-capable UE 120. That is, the UE 120 is configured with one or more devices or components that enable the UE 120 to perform one or more EH techniques. The one or more EH techniques of which the UE 120 is capable may include, for example, an RF EH technique (e.g., using a separated receiver architecture, a time-switching architecture, a power splitting architecture, or the like), a solar EH technique, or a vibration EH technique, among other examples.

As shown by reference 405, the UE 120 may transmit, and the base station 110 may receive, an indication of an energy mode in which the UE 120 is to operate. In some aspects, the energy mode is a mode of operation that defines a type of energy harvesting to be performed by the UE 120 and a level of engagement of the UE 120 in association with performing the indicated type of energy harvesting. Thus, in some aspects, the energy mode indicates the energy harvesting to be performed by the UE 120 and the level of engagement of the UE 120 in association with performing the indicated type of energy harvesting. The type of energy harvesting may include, for example, one or more of RF energy harvesting using a power splitting technique, RF energy harvesting using a time-switching technique, RF energy harvesting using a separated technique, solar energy harvesting, or vibration energy harvesting, among other examples. The level of engagement may indicate, for example, a percentage (e.g., a percentage of time, a percentage of resources, a percentage of processing power, or the like) of being engaged with the one or more energy harvesting activities during operating in the energy mode. In some aspects, the energy mode may indicate one or more types of energy harvesting and one or more respective levels of engagement. As one example, a first energy mode may indicate that the UE 120 is to perform RF energy harvesting using a time-switching technique for a percentage of time corresponding to a first time-switching factor value (e.g., α₁). As another example, a second energy mode may indicate that the UE 120 is to perform RF energy harvesting using the time-switching technique for a percentage of time corresponding to a second time-switching factor value (e.g., α₂). As another example, a third mode may indicate that the UE 120 is to perform RF energy harvesting using power splitting technique for a percentage of power corresponding to first power splitting factor value (e.g., ρ₁). As another example, a fourth energy mode may indicate that the UE 120 is to perform RF energy harvesting using the power splitting technique for a percentage of power corresponding to a second power splitting factor value (e.g., ρ₂). As another example, fifth energy mode may indicate that the UE 120 is to perform RF energy harvesting using the time-switching technique for a percentage of time corresponding to a third time-switching factor value (e.g., α₃) and using a vibration energy harvesting technique for another particular percentage of time. As another example, a sixth energy mode may indicate that the UE 120 is to perform RF energy harvesting using the time-switching technique for a percentage of time corresponding to a fourth time-switching factor value (e.g., α₄) and using the power splitting technique for a percentage of power corresponding to a third power splitting factor value (e.g., ρ₃). Notably, these examples of energy modes are provided for illustrative purposes, and other examples are possible.

In some aspects, the energy mode is one of a plurality of energy modes associated with a class of the UE 120. A UE class (also referred to as a UE type) may be defined as a group of UEs 120 having a set of common capabilities or characteristics. Such capabilities or characteristics may include, for example, a processing capability, a power model used for data processing (e.g., downlink processing, uplink processing, sidelink processing, or the like), an energy harvesting technology capability, an average charging rate achievable during energy harvesting, or a minimum charging rate achievable during energy harvesting, among other examples. Thus, in some aspects, there may be a plurality of energy modes associated with a given class, where each energy mode is associated with one or more types of energy harvesting and, for a given energy mode, each type of energy harvesting is associated with a respective level of engagement.

In some aspects, an energy mode may be associated with a value, and the UE 120 may indicate the energy mode by transmitting a communication carrying the value associated with the energy mode. In some aspects, the energy mode may be associated with the value via an applicable wireless communication standard or via signaling from a base station 110 (e.g., via a table signaled via radio resource control (RRC) signaling or a medium access control (MAC) control element), among other examples. As one example, a first value may be associated with a first type of energy harvesting (e.g., RF energy harvesting using a time-switching technique) and a first level of engagement (e.g., a first value for an alpha factor), a second value may be associated with the first type of energy harvesting and a second level of engagement (e.g., a second value for the alpha factor), a third value may be associated with a second type of energy harvesting (e.g., RF energy harvesting using a power-splitting technique) and a third level of engagement (e.g., a first value for a rho factor), and so on.

In some aspects, the UE 120 may select the energy mode based at least in part on at least one of the class of the UE 120, an energy state of the UE 120 (e.g., an amount of battery power), or an energy harvesting charging rate of the UE 120. That is, in some aspects, the UE 120 may select the energy mode in which the UE 120 is to operate based at least in part on one or more factors, where these one or more factors can include the class of the UE 120, the energy state of the UE 120, or the energy harvesting charging rate of the UE 120.

As shown by reference 410, the UE 120 may operate according to a configuration associated with the energy mode based at least in part on transmitting the indication of the energy mode. That is, after transmitting the indication of the energy mode, the UE 120 may begin operation according to a configuration associated with the energy mode. In some aspects, the configuration indicates one or more parameters based at least in part on which the UE 120 is to operate in association with performing energy harvesting or participating in wireless communications while operating in the energy mode.

In some aspects, the UE 120 may operate according to the configuration without receiving an acknowledgment (ACK) of the indication of the energy mode. That is, the UE 120 may in some aspects begin operation according to the configuration without receiving (e.g., without the base station 110 transmitting) an ACK of the indication. Alternatively, in some aspects, the UE 120 may operate according to the configuration based at least in part on receiving an ACK. For example, the UE 120 may transmit, and the base station 110 may receive, the indication of the energy mode. The base station 110 may then transmit, and the UE 120 may receive, an ACK of the indication, and the UE 120 and the base station 110 may begin operating according to the configuration accordingly.

In some aspects, the UE 120 may transmit, and the base station 110 may receive, an indication of whether concurrent sidelink and access link (e.g., Uu link) operation is supported during operation in the energy mode. That is, in some aspects, the UE 120 can, for a given energy mode, indicate whether the UE 120 can support sidelink and access link communication during the same time window (e.g., whether either sidelink or access link communication should be canceled in a given time window during operation of the UE 120 in the energy mode). In some aspects, whether concurrent sidelink and access link operation is supported during operation in the energy mode can be defined or indicated in another manner, such as by an applicable wireless communication standard.

In some aspects, the UE 120 may receive the configuration associated with the energy mode from, for example, the base station 110. In some aspects, the UE 120 may receive the configuration prior to transmitting the indication. Alternatively, in some aspects, the UE 120 may receive the configuration after transmitting the indication (e.g., the base station 110 may transmit the configuration after receiving the indication of the energy mode from the UE 120). In some aspects, the base station 110 may transmit, and the UE 120 may receive, the configuration in control information, such as downlink control information (DCI), sidelink control information (SCI), or the like.

In some aspects, a characteristic of wake-up signal operation is based at least in part on the energy mode. That is, in some aspects, monitoring of a wake-up signal may be a function of the energy mode. For example, in some aspects, the configuration associated with the energy mode may indicate whether the UE 120 is to attempt to receive wake-up signaling and, similarly, whether the base station 110 is to transmit wake-up signaling to the UE 120. As another example, in some aspects, the configuration may indicate a periodicity of wake-up signaling to be transmitted by the base station 110 for reception by the UE 120. In some aspects, a periodicity of wake-up signaling for a given energy mode may be different (e.g., longer than) a periodicity of wake-up signaling for another energy mode.

In some aspects, dormancy of a secondary cell associated with the UE 120 may be based at least in part on the energy mode. Thus, in some aspects, dormancy of a secondary cell may differ among energy modes (e.g., for each component carrier). In some aspects, when configuring the component carrier, the base station 110 can indicate to the UE 120 whether the component carrier is active in a given energy mode. Thus, in some aspects, the configuration associated with the energy mode may indicate dormancy (or non-dormancy) of a secondary cell.

In some aspects, a dormant secondary cell may be a secondary cell on which one or more channel state information (CSI) measurements or one or more radio resource management (RRM) measurements are performed, where a periodicity of such measurements can change based at least in part on the energy mode (per class). In some aspects, a dormant secondary cell may be a secondary cell on which one or more measurements or reporting is performed, where a periodicity of such measurements and reporting can change based at least in part on based on the energy mode (per class). In some aspects, a dormant secondary cell may be a secondary cell that is inactive (e.g., until a state change).

In some aspects, a measurement periodicity for a reference signal is based at least in part on the energy mode. That is, in some aspects, a reference signal (e.g., a channel state information reference signal (CSI-RS) of a secondary cell) measurement periodicity can differ among energy modes. Thus, in some aspects, the configuration associated with the energy mode may indicate a periodicity of a reference signal.

In some aspects, the UE 120 may transmit access link operation information associated with the energy mode, and the configuration may be based at least in part on the access link operation information. In some aspects, the access link operation information may include, for example, an indication of a quantity of active component carriers or bandwidth parts per component carrier supported by the UE 120 during operation in the energy mode. As another example, the access link operation information may include an indication of a quantity of inactive component carriers or bandwidth parts per component carrier supported by the UE 120 during operation in the energy mode. As another example, the access link operation information may include an indication of a quantity of dormant component carriers or bandwidth parts per component carrier supported by the UE 120 during operation in the energy mode. As another example, the access link operation information may include an indication of an amount of time needed to change a bandwidth part or modify a component carrier during operation in the energy mode. As another example, the access link operation information may include an indication of an amount of repetition of uplink resources (e.g., sounding reference signal (SRS) resources, physical uplink control channel (PUCCH) resources, physical uplink shared channel (PUSCH) resources, or the like) supported during operation in the energy mode. As another example, the access link operation information may include an indication of a quantity of reporting configurations in a CSI-RS supported during operation in the energy mode (e.g., during a given period of time). As another example, the access link operation information may include an indication of a quantity of CSI-RS processes or CSI-RS resources per report (or bundled in a single PUSCH communication in a scenario where multiple reporting configurations are triggers) supported by the UE 120 during operation in the energy mode. As another example, the access link operation information may include an indication of a maximum transmit power during operation in the energy mode. As another example, the access link operation information may include an indication of a quantity of reference signal resources (e.g., SRS resources, CSI-RS resources, or the like) supported during operation in the energy mode. As another example, the access link operation information may include an indication of a status of a power amplifier (PA) of the UE 120 (e.g., whether a PA is present, whether the PA is powered on, or the like) during operation in the energy mode.

In some aspects, energy harvesting may impact operation of sidelink communications (e.g., communications on a sidelink between the UE 120 and another UE, such as another UE 120). Thus, the presence of one or more EH devices (e.g., one or more UEs 120) may impact configuration of and behavior of the UE 120 with respect to sidelink communications.

Therefore, in some aspects, the UE 120 may transmit sidelink operation information associated with the energy mode, and the configuration may be based at least in part on the sidelink operation information. In some aspects, the sidelink operation information may include, for example, an indication of a quantity of component carriers, bandwidth parts per component carrier, or resource pools supported by the UE 120 during operation in the energy mode. As another example, the sidelink operation information may include an indication of a sidelink relaying capability during operation in the energy mode. As another example, the sidelink operation information may include an indication of a wireless charging capability of the UE 120 during operation in the energy mode (e.g., whether the UE 120 can wirelessly charge another EH device, such as an IoT device). As another example, the sidelink operation information may include an indication of a status of a PA of the UE 120 during operation in the energy mode. As another example, the sidelink operation information may include an indication of a sensing capability during operation in the energy mode.

In some aspects, the configuration indicates a set of parameters for a resource pool to be used in association with participating in sidelink communications during operation in the energy mode. In some aspects, the resource pool associated with the configuration may be a resource pool that can be used by energy harvesting devices (e.g., UEs 120) and non-energy-harvesting UEs. In such a scenario, the set of parameters may include one or more parameters related to a sensing configuration (e.g., a reference signal received power (RSRP) threshold), a modulation and coding scheme (MCS), a channel busy ratio (CBR) configuration, a power control scheme, or the like, for each UE class and each energy mode. Alternatively, in some aspects, the resource pool associated with the configuration may be a resource pool that is dedicated for use by energy harvesting devices (e.g., UEs 120) to transmit or receive wireless communications.

In some aspects, the configuration may indicate one or more parameters or characteristics associated with inter-UE coordination performed in association with participating in sidelink communications during operation in the energy mode. For example, the configuration may indicate a periodicity of reporting for inter-UE coordination during operation in the energy mode. The periodicity of reporting by the UE 120 could be different from a periodicity of non-energy-harvesting UEs. In some aspects, within the energy mode, the periodicity may vary for different energy states of the UE 120. In some aspects, the UE 120 may transmit an indication of the periodicity of reporting for inter-UE coordination during operation in the energy mode. That is, the UE 120 can indicate (e.g., to other UEs, such as other UEs 120) the periodicity of reporting (e.g., for a given energy mode). Thus, if other UEs are informed of the energy mode, then these other UEs can determine the periodicity of reporting used by the UE 120. As another example, the configuration may indicate an RSRP threshold for inter-UE coordination during operation in the energy mode. Thus, in some aspects, the RSRP threshold for a given energy mode can be modified or a previously configured threshold could be modified for a given energy mode based at least in part on the configuration.

In some aspects, the configuration may indicate a set of resources of a resource pool assigned to the UE 120 during operation in the energy mode. Thus, in some aspects, the UE 120 can be assigned a set of resources within the resource pool to sense in a given sensing window. In some aspects, an indication of the set of resources assigned to the UE 120 may be provided to other UEs to prevent the other UEs from using the set of resources.

In some aspects, the configuration may indicate a synchronization signal transmission periodicity to be used during operation in the energy mode. Notably, the UE 120 may rarely (e.g., at a lower periodicity than a non-energy-harvesting UE) need to transmit synchronization signals. However, in a scenario when the UE 120 needs to transmit a synchronization signal, the periodicity of the synchronization signals can be a indicated in the configuration associated with the energy mode.

As shown by reference 415, the base station 110 may operate according to the configuration associated with the energy mode based at least in part on receiving the indication of the energy mode. That is, upon receiving the indication of the energy mode, the base station 110 may operate according to the configuration.

In this way, configuration and coordination between the UE 120 and one or more other network entities (e.g., the base station 110, one or more other UEs 120, or one or more non-energy-harvesting UEs) can be supported, thereby enabling efficient and reliable communication in a wireless network including one or more energy harvesting devices.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 120) performs operations associated with EH device configuration, as described herein.

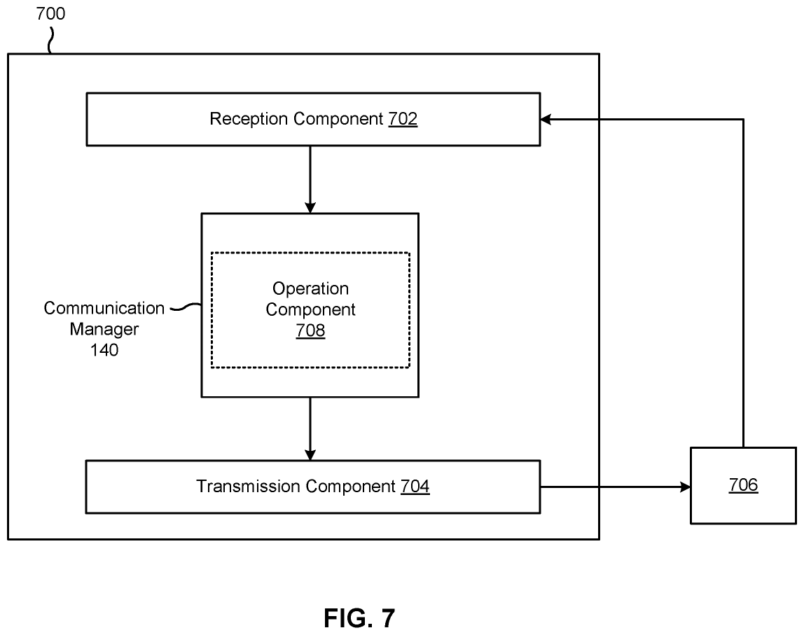

As shown in FIG. 5, in some aspects, process 500 may include transmitting an indication of an energy mode in which the UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE (block 510). For example, the UE (e.g., using communication manager 140 and/or transmission component 704, depicted in FIG. 7) may transmit an indication of an energy mode in which the UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE, as described above.

As further shown in FIG. 5, in some aspects, process 500 may include operating according to a configuration associated with the energy mode based at least in part on transmitting the indication of the energy mode (block 520). For example, the UE (e.g., using communication manager 140 and/or operation component 708, depicted in FIG. 7) may operate according to a configuration associated with the energy mode based at least in part on transmitting the indication of the energy mode, as described above.

Process 500 may include additional aspects, such as any single aspect or any combination of aspects described below and/or in connection with one or more other processes described elsewhere herein.

In a first aspect, process 500 includes selecting the energy mode of the UE based at least in part on at least one of the class of the UE, an energy state of the UE, or an energy harvesting charging rate of the UE.

In a second aspect, alone or in combination with the first aspect, operating according to the configuration comprises operating according to the configuration without receiving an ACK of the indication of the energy mode.

In a third aspect, alone or in combination with one or more of the first and second aspects, process 500 includes receiving an ACK of the indication after transmitting the indication, wherein operating according to the configuration comprises operating according to the configuration based at least in part on receiving the ACK.

In a fourth aspect, alone or in combination with one or more of the first through third aspects, process 500 includes receiving, after transmitting the indication of the energy mode, control information indicating the configuration, wherein operating according to the configuration comprises operating according to the configuration.

In a fifth aspect, alone or in combination with one or more of the first through fourth aspects, process 500 includes receiving the configuration associated with the energy mode.

In a sixth aspect, alone or in combination with one or more of the first through fifth aspects, process 500 includes transmitting an indication of whether concurrent sidelink and access link operation is supported during operation in the energy mode.

In a seventh aspect, alone or in combination with one or more of the first through sixth aspects, a characteristic of wake-up signal operation is based at least in part on the energy mode.

In an eighth aspect, alone or in combination with one or more of the first through seventh aspects, dormancy of a secondary cell associated with the UE is based at least in part on the energy mode.

In a ninth aspect, alone or in combination with one or more of the first through eighth aspects, a measurement periodicity for a reference signal is based at least in part on the energy mode.

In a tenth aspect, alone or in combination with one or more of the first through ninth aspects, process 500 includes transmitting access link operation information associated with the energy mode, wherein the configuration is based at least in part on the access link operation information.

In an eleventh aspect, alone or in combination with one or more of the first through tenth aspects, the access link operation information includes an indication of at least one of a quantity of active component carriers or bandwidth parts per component carrier supported during operation in the energy mode, a quantity of inactive component carriers or bandwidth parts per component carrier supported during operation in the energy mode, a quantity of dormant component carriers or bandwidth parts per component carrier supported during operation in the energy mode, an amount of time needed to change a bandwidth part or modify a component carrier during operation in the energy mode, an amount of repetition of uplink resources supported during operation in the energy mode, a quantity of reporting configurations in a CSI-RS supported during operation in the energy mode, a quantity of CSI-RS processes or CSI-RS resources per report supported during operation in the energy mode, a maximum transmit power during operation in the energy mode, a quantity of reference signal resources supported during operation in the energy mode, or a status of a PA.

In a twelfth aspect, alone or in combination with one or more of the first through eleventh aspects, process 500 includes transmitting sidelink operation information associated with the energy mode, wherein the configuration is based at least in part on the sidelink operation information.

In a thirteenth aspect, alone or in combination with one or more of the first through twelfth aspects, the sidelink operation information includes an indication of at least one of a quantity of component carriers, bandwidth parts per component carrier, or resource pools supported during operation in the energy mode, a sidelink relaying capability during operation in the energy mode, a wireless charging capability during operation in the energy mode, a sensing capability during operation in the energy mode, or a status of a PA.

In a fourteenth aspect, alone or in combination with one or more of the first through thirteenth aspects, the configuration indicates a set of parameters for a resource pool to be used during operation in the energy mode.

In a fifteenth aspect, alone or in combination with one or more of the first through fourteenth aspects, the resource pool is a resource pool dedicated for use by energy harvesting devices.

In a sixteenth aspect, alone or in combination with one or more of the first through fifteenth aspects, the configuration indicates a periodicity of reporting for inter-UE coordination during operation in the energy mode.

In a seventeenth aspect, alone or in combination with one or more of the first through sixteenth aspects, process 500 includes transmitting an indication of a periodicity of reporting for inter-UE coordination during operation in the energy mode.

In an eighteenth aspect, alone or in combination with one or more of the first through seventeenth aspects, the configuration indicates an RSRP threshold for inter-UE coordination during operation in the energy mode.

In a nineteenth aspect, alone or in combination with one or more of the first through eighteenth aspects, the configuration indicates a set of resources of a resource pool assigned to the UE during operation in the energy mode.

In a twentieth aspect, alone or in combination with one or more of the first through nineteenth aspects, the configuration indicates a synchronization signal transmission periodicity during operation in the energy mode.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a network entity, in accordance with the present disclosure. Example process 600 is an example where the network entity (e.g., base station 110) performs operations associated with EH device configuration, as described herein.

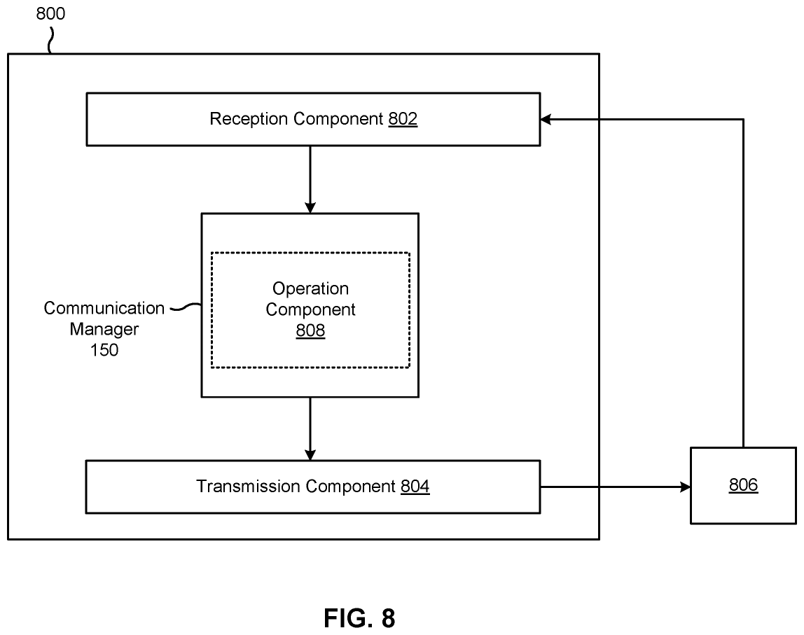

As shown in FIG. 6, in some aspects, process 600 may include receiving an indication of an energy mode in which a UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE (block 610). For example, the network entity (e.g., using communication manager 150 and/or reception component 802, depicted in FIG. 8) may receive an indication of an energy mode in which a UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE, as described above.

As further shown in FIG. 6, in some aspects, process 600 may include operating according to a configuration associated with the energy mode based at least in part on receiving the indication of the energy mode (block 620). For example, the network entity (e.g., using communication manager 150 and/or operation component 808, depicted in FIG. 8) may operate according to a configuration associated with the energy mode based at least in part on receiving the indication of the energy mode, as described above.

Process 600 may include additional aspects, such as any single aspect or any combination of aspects described below and/or in connection with one or more other processes described elsewhere herein.

In a first aspect, operating according to the configuration comprises operating according to the configuration without transmitting an ACK of the indication of the energy mode.

In a second aspect, alone or in combination with the first aspect, process 600 includes transmitting an ACK of the indication after receiving the indication, wherein operating according to the configuration comprises operating according to the configuration based at least in part on transmitting the ACK.

In a third aspect, alone or in combination with one or more of the first and second aspects, process 600 includes transmitting, after receiving the indication of the energy mode, control information indicating the configuration, wherein operating according to the configuration comprises operating according to the configuration indicated by the control information.

In a fourth aspect, alone or in combination with one or more of the first through third aspects, process 600 includes transmitting the configuration associated with the energy mode.

In a fifth aspect, alone or in combination with one or more of the first through fourth aspects, process 600 includes receiving an indication of whether concurrent sidelink and access link operation is supported during operation in the energy mode.

In a sixth aspect, alone or in combination with one or more of the first through fifth aspects, a characteristic of wake-up signal operation is based at least in part on the energy mode.

In a seventh aspect, alone or in combination with one or more of the first through sixth aspects, dormancy of a secondary cell associated with the UE is based at least in part on the energy mode.

In an eighth aspect, alone or in combination with one or more of the first through seventh aspects, a measurement periodicity for a reference signal is based at least in part on the energy mode.

In a ninth aspect, alone or in combination with one or more of the first through eighth aspects, process 600 includes receiving access link operation information associated with the energy mode, wherein the configuration is based at least in part on the access link operation information.

In a tenth aspect, alone or in combination with one or more of the first through ninth aspects, the access link operation information includes an indication of at least one of a quantity of active component carriers or bandwidth parts per component carrier supported during operation in the energy mode, a quantity of inactive component carriers or bandwidth parts per component carrier supported during operation in the energy mode, a quantity of dormant component carriers or bandwidth parts per component carrier supported during operation in the energy mode, an amount of time needed to change a bandwidth part or modify a component carrier during operation in the energy mode, an amount of repetition of uplink resources supported during operation in the energy mode, a quantity of reporting configurations in a CSI-RS supported during operation in the energy mode, a quantity of CSI-RS processes or CSI-RS resources per report supported during operation in the energy mode, a maximum transmit power during operation in the energy mode, a quantity of reference signal resources supported during operation in the energy mode, or a status of a PA.

In an eleventh aspect, alone or in combination with one or more of the first through tenth aspects, process 600 includes receiving sidelink operation information associated with the energy mode, wherein the configuration is based at least in part on the sidelink operation information.

In a twelfth aspect, alone or in combination with one or more of the first through eleventh aspects, the sidelink operation information includes an indication of at least one of a quantity of component carriers, bandwidth parts per component carrier, or resource pools supported during operation in the energy mode, a sidelink relaying capability during operation in the energy mode, a wireless charging capability during operation in the energy mode, a sensing capability during operation in the energy mode, or a status of a PA.

In a thirteenth aspect, alone or in combination with one or more of the first through twelfth aspects, the configuration indicates a set of parameters for a resource pool to be used during operation in the energy mode.

In a fourteenth aspect, alone or in combination with one or more of the first through thirteenth aspects, the resource pool is a resource pool dedicated for use by energy harvesting devices.

In a fifteenth aspect, alone or in combination with one or more of the first through fourteenth aspects, the configuration indicates a periodicity of reporting for inter-UE coordination during operation in the energy mode.

In a sixteenth aspect, alone or in combination with one or more of the first through fifteenth aspects, the configuration indicates an RSRP threshold for inter-UE coordination during operation in the energy mode.

In a seventeenth aspect, alone or in combination with one or more of the first through sixteenth aspects, the configuration indicates a set of resources of a resource pool assigned to the UE during operation in the energy mode.

In an eighteenth aspect, alone or in combination with one or more of the first through seventeenth aspects, the configuration indicates a synchronization signal transmission periodicity during operation in the energy mode.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include an operation component 708, among other examples.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The transmission component 704 may transmit an indication of an energy mode in which the UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE. The operation component 708 may operate according to a configuration associated with the energy mode based at least in part on transmitting the indication of the energy mode.

The operation component 708 may select the energy mode of the UE based at least in part on at least one of the class of the UE, an energy state of the UE, or an energy harvesting charging rate of the UE.

The reception component 702 may receive an ACK of the indication after transmitting the indication, wherein operating according to the configuration comprises operating according to the configuration based at least in part on receiving the ACK.

The reception component 702 may receive, after transmitting the indication of the energy mode, control information indicating the configuration, wherein operating according to the configuration comprises operating according to the configuration.

The reception component 702 may receive the configuration associated with the energy mode.

The transmission component 704 may transmit an indication of whether concurrent sidelink and access link operation is supported during operation in the energy mode.

The transmission component 704 may transmit access link operation information associated with the energy mode, wherein the configuration is based at least in part on the access link operation information.

The transmission component 704 may transmit sidelink operation information associated with the energy mode, wherein the configuration is based at least in part on the sidelink operation information.

The transmission component 704 may transmit an indication of a periodicity of reporting for inter-UE coordination during operation in the energy mode.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network entity, or a network entity may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150. The communication manager 150 may include an operation component 808, among other examples.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network entity described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the network entity described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the network entity described in connection with FIG. 2. In some aspects, the transmission component 804 may be co-located with the reception component 802 in a transceiver.

The reception component 802 may receive an indication of an energy mode in which a UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE. The operation component 808 may operate according to a configuration associated with the energy mode based at least in part on receiving the indication of the energy mode. In some aspects, the energy mode is a mode of operation that defines a type of energy harvesting to be performed by the UE and a level of engagement of the UE in association with performing the indicated type of energy harvesting. Thus, in some aspects, the energy mode indicates the energy harvesting to be performed by the UE and the level of engagement of the UE in association with performing the indicated type of energy harvesting.

The transmission component 804 may transmit an ACK of the indication after receiving the indication, wherein operating according to the configuration comprises operating according to the configuration based at least in part on transmitting the ACK.

The transmission component 804 may transmit, after receiving the indication of the energy mode, control information indicating the configuration, wherein operating according to the configuration comprises operating according to the configuration indicated by the control information.

The transmission component 804 may transmit the configuration associated with the energy mode.

The reception component 802 may receive an indication of whether concurrent sidelink and access link operation is supported during operation in the energy mode.

The reception component 802 may receive access link operation information associated with the energy mode, wherein the configuration is based at least in part on the access link operation information.

The reception component 802 may receive sidelink operation information associated with the energy mode, wherein the configuration is based at least in part on the sidelink operation information.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: transmitting an indication of an energy mode in which the UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE; and operating according to a configuration associated with the energy mode based at least in part on transmitting the indication of the energy mode.

Aspect 2: The method of Aspect 1, further comprising selecting the energy mode of the UE based at least in part on at least one of the class of the UE, an energy state of the UE, or an energy harvesting charging rate of the UE.

Aspect 3: The method of any of Aspects 1-2, wherein operating according to the configuration comprises operating according to the configuration without receiving an ACK of the indication of the energy mode.

Aspect 4: The method of any of Aspects 1-2, further comprising receiving an ACK of the indication after transmitting the indication, wherein operating according to the configuration comprises operating according to the configuration based at least in part on receiving the ACK.

Aspect 5: The method of any of Aspects 1-4, further comprising receiving, after transmitting the indication of the energy mode, control information indicating the configuration, wherein operating according to the configuration comprises operating according to the configuration.

Aspect 6: The method of any of Aspects 1-5, further comprising receiving the configuration associated with the energy mode.

Aspect 7: The method of any of Aspects 1-6, further comprising transmitting an indication of whether concurrent sidelink and access link operation is supported during operation in the energy mode.

Aspect 8: The method of any of Aspects 1-7, wherein a characteristic of wake-up signal operation is based at least in part on the energy mode.

Aspect 9: The method of any of Aspects 1-8, wherein dormancy of a secondary cell associated with the UE is based at least in part on the energy mode.

Aspect 10: The method of any of Aspects 1-9, wherein a measurement periodicity for a reference signal is based at least in part on the energy mode.

Aspect 11: The method of any of Aspects 1-10, further comprising transmitting access link operation information associated with the energy mode, wherein the configuration is based at least in part on the access link operation information.

Aspect 12: The method of Aspect 11, wherein the access link operation information includes an indication of at least one of: a quantity of active component carriers or bandwidth parts per component carrier supported during operation in the energy mode, a quantity of inactive component carriers or bandwidth parts per component carrier supported during operation in the energy mode, a quantity of dormant component carriers or bandwidth parts per component carrier supported during operation in the energy mode, an amount of time needed to change a bandwidth part or modify a component carrier during operation in the energy mode, an amount of repetition of uplink resources supported during operation in the energy mode, a quantity of reporting configurations in a CSI-RS supported during operation in the energy mode, a quantity of CSI-RS processes or CSI-RS resources per report supported during operation in the energy mode, a maximum transmit power during operation in the energy mode, a quantity of reference signal resources supported during operation in the energy mode, or a status of a PA.

Aspect 13: The method of any of Aspects 1-12, further comprising transmitting sidelink operation information associated with the energy mode, wherein the configuration is based at least in part on the sidelink operation information.

Aspect 14: The method of Aspect 13, wherein the sidelink operation information includes an indication of at least one of: a quantity of component carriers, bandwidth parts per component carrier, or resource pools supported during operation in the energy mode, a sidelink relaying capability during operation in the energy mode, a wireless charging capability during operation in the energy mode, a sensing capability during operation in the energy mode, or a status of a PA.

Aspect 15: The method of any of Aspects 1-14, wherein the configuration indicates a set of parameters for a resource pool to be used during operation in the energy mode.

Aspect 16: The method of Aspect 15, wherein the resource pool is a resource pool dedicated for use by energy harvesting devices.

Aspect 17: The method of any of Aspects 1-16, wherein the configuration indicates a periodicity of reporting for inter-UE coordination during operation in the energy mode.

Aspect 18: The method of any of Aspects 1-17, further comprising transmitting an indication of a periodicity of reporting for inter-UE coordination during operation in the energy mode.

Aspect 19: The method of any of Aspects 1-18, wherein the configuration indicates an RSRP threshold for inter-UE coordination during operation in the energy mode.

Aspect 20: The method of any of Aspects 1-19, wherein the configuration indicates a set of resources of a resource pool assigned to the UE during operation in the energy mode.

Aspect 21: The method of any of Aspects 1-20, wherein the configuration indicates a synchronization signal transmission periodicity during operation in the energy mode.

Aspect 22: A method of wireless communication performed by a network entity, comprising: receiving an indication of an energy mode in which a UE is to operate, wherein the energy mode indicates a type of energy harvesting to be performed by the UE and a level of engagement of the UE in association with performing the type of energy harvesting, and wherein the energy mode is one of a plurality of energy modes associated with a class of the UE; and operating according to a configuration associated with the energy mode based at least in part on receiving the indication of the energy mode.

Aspect 23: The method of Aspect 22, wherein operating according to the configuration comprises operating according to the configuration without transmitting an ACK of the indication of the energy mode.

Aspect 24: The method of Aspect 22, further comprising transmitting an ACK of the indication after receiving the indication, wherein operating according to the configuration comprises operating according to the configuration based at least in part on transmitting the ACK.

Aspect 25: The method of any of Aspects 22-24, further comprising transmitting, after receiving the indication of the energy mode, control information indicating the configuration, wherein operating according to the configuration comprises operating according to the configuration indicated by the control information.

Aspect 26: The method of any of Aspects 22-25, further comprising transmitting the configuration associated with the energy mode.

Aspect 27: The method of any of Aspects 22-26, further comprising receiving an indication of whether concurrent sidelink and access link operation is supported during operation in the energy mode.

Aspect 28: The method of any of Aspects 22-27, wherein a characteristic of wake-up signal operation is based at least in part on the energy mode.

Aspect 29: The method of any of Aspects 22-28, wherein dormancy of a secondary cell associated with the UE is based at least in part on the energy mode.

Aspect 30: The method of any of Aspects 22-29, wherein a measurement periodicity for a reference signal is based at least in part on the energy mode.

Aspect 31: The method of any of Aspects 22-30, further comprising receiving access link operation information associated with the energy mode, wherein the configuration is based at least in part on the access link operation information.

Aspect 32: The method of Aspect 31, wherein the access link operation information includes an indication of at least one of: a quantity of active component carriers or bandwidth parts per component carrier supported during operation in the energy mode, a quantity of inactive component carriers or bandwidth parts per component carrier supported during operation in the energy mode, a quantity of dormant component carriers or bandwidth parts per component carrier supported during operation in the energy mode, an amount of time needed to change a bandwidth part or modify a component carrier during operation in the energy mode, an amount of repetition of uplink resources supported during operation in the energy mode, a quantity of reporting configurations in a CSI-RS supported during operation in the energy mode, a quantity of CSI-RS processes or CSI-RS resources per report supported during operation in the energy mode, a maximum transmit power during operation in the energy mode, a quantity of reference signal resources supported during operation in the energy mode, or a status of a PA.

Aspect 33: The method of any of Aspects 22-32, further comprising receiving sidelink operation information associated with the energy mode, wherein the configuration is based at least in part on the sidelink operation information.

Aspect 34: The method of Aspect 33, wherein the sidelink operation information includes an indication of at least one of: a quantity of component carriers, bandwidth parts per component carrier, or resource pools supported during operation in the energy mode, a sidelink relaying capability during operation in the energy mode, a wireless charging capability during operation in the energy mode, a sensing capability during operation in the energy mode, or a status of a PA.

Aspect 35: The method of any of Aspects 22-24, wherein the configuration indicates a set of parameters for a resource pool to be used during operation in the energy mode.

Aspect 36: The method of Aspect 35, wherein the resource pool is a resource pool dedicated for use by energy harvesting devices.

Aspect 37: The method of any of Aspects 22-36, wherein the configuration indicates a periodicity of reporting for inter-UE coordination during operation in the energy mode.

Aspect 38: The method of any of Aspects 22-37, wherein the configuration indicates an RSRP threshold for inter-UE coordination during operation in the energy mode.

Aspect 39: The method of any of Aspects 22-38, wherein the configuration indicates a set of resources of a resource pool assigned to the UE during operation in the energy mode.

Aspect 40: The method of any of Aspects 22-39, wherein the configuration indicates a synchronization signal transmission periodicity during operation in the energy mode.

Aspect 41: An apparatus for wireless communication at a device, comprising a processor; memory coupled with the processor; and instructions stored in the memory and executable by the processor to cause the apparatus to perform the method of one or more of Aspects 1-21.

Aspect 42: A device for wireless communication, comprising a memory and one or more processors coupled to the memory, the one or more processors configured to perform the method of one or more of Aspects 1-21.

Aspect 43: An apparatus for wireless communication, comprising at least one means for performing the method of one or more of Aspects 1-21.

Aspect 44: A non-transitory computer-readable medium storing code for wireless communication, the code comprising instructions executable by a processor to perform the method of one or more of Aspects 1-21.

Aspect 45: A non-transitory computer-readable medium storing a set of instructions for wireless communication, the set of instructions comprising one or more instructions that, when executed by one or more processors of a device, cause the device to perform the method of one or more of Aspects 1-21.

Aspect 46: An apparatus for wireless communication at a device, comprising a processor; memory coupled with the processor; and instructions stored in the memory and executable by the processor to cause the apparatus to perform the method of one or more of Aspects 22-40.

Aspect 47: A device for wireless communication, comprising a memory and one or more processors coupled to the memory, the one or more processors configured to perform the method of one or more of Aspects 22-40.

Aspect 48: An apparatus for wireless communication, comprising at least one means for performing the method of one or more of Aspects 22-40.

Aspect 49: A non-transitory computer-readable medium storing code for wireless communication, the code comprising instructions executable by a processor to perform the method of one or more of Aspects 22-40.

Aspect 50: A non-transitory computer-readable medium storing a set of instructions for wireless communication, the set of instructions comprising one or more instructions that, when executed by one or more processors of a device, cause the device to perform the method of one or more of Aspects 22-40.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
transmitting an indication of an energy mode in which the UE is to operate,
wherein the energy mode indicates a type of energy harvesting to be performed by the UE and a level of engagement of the UE in association with performing the type of energy harvesting, and
wherein the energy mode is one of a plurality of energy modes associated with a class of the UE; and
operating according to a configuration associated with the energy mode based at least in part on transmitting the indication of the energy mode.

2. The method of claim 1, further comprising selecting the energy mode of the UE based at least in part on at least one of the class of the UE, an energy state of the UE, or an energy harvesting charging rate of the UE.

3. The method of claim 1, wherein operating according to the configuration comprises operating according to the configuration without receiving an acknowledgment (ACK) of the indication of the energy mode.

4. The method of claim 1, further comprising receiving an acknowledgment (ACK) of the indication after transmitting the indication,
wherein operating according to the configuration comprises operating according to the configuration based at least in part on receiving the ACK.

5. The method of claim 1, further comprising receiving, after transmitting the indication of the energy mode, control information indicating the configuration,
wherein operating according to the configuration comprises operating according to the configuration.

6. The method of claim 1, further comprising receiving the configuration associated with the energy mode.

7. The method of claim 1, further comprising transmitting an indication of whether concurrent sidelink and access link operation is supported during operation in the energy mode.

8. The method of claim 1, wherein a characteristic of wake-up signal operation is based at least in part on the energy mode.

9. The method of claim 1, wherein dormancy of a secondary cell associated with the UE is based at least in part on the energy mode.

10. The method of claim 1, wherein a measurement periodicity for a reference signal is based at least in part on the energy mode.

11. The method of claim 1, further comprising transmitting access link operation information associated with the energy mode, wherein the configuration is based at least in part on the access link operation information.

12. The method of claim 11, wherein the access link operation information includes an indication of at least one of:
a quantity of active component carriers or bandwidth parts per component carrier supported during operation in the energy mode,
a quantity of inactive component carriers or bandwidth parts per component carrier supported during operation in the energy mode,
a quantity of dormant component carriers or bandwidth parts per component carrier supported during operation in the energy mode,
an amount of time needed to change a bandwidth part or modify a component carrier during operation in the energy mode,
an amount of repetition of uplink resources supported during operation in the energy mode,
a quantity of reporting configurations in a channel state information reference signal (CSI-RS) supported during operation in the energy mode,
a quantity of CSI-RS processes or CSI-RS resources per report supported during operation in the energy mode,
a maximum transmit power during operation in the energy mode,
a quantity of reference signal resources supported during operation in the energy mode, or
a status of a power amplifier (PA).

13. The method of claim 1, further comprising transmitting sidelink operation information associated with the energy mode, wherein the configuration is based at least in part on the sidelink operation information.

14. The method of claim 13, wherein the sidelink operation information includes an indication of at least one of:
a quantity of component carriers, bandwidth parts per component carrier, or resource pools supported during operation in the energy mode,
a sidelink relaying capability during operation in the energy mode,
a wireless charging capability during operation in the energy mode,
a sensing capability during operation in the energy mode, or
a status of a power amplifier (PA).

15. The method of claim 1, wherein the configuration indicates a set of parameters for a resource pool to be used during operation in the energy mode.

16. The method of claim 15, wherein the resource pool is a resource pool dedicated for use by energy harvesting devices.

17. The method of claim 1, wherein the configuration indicates a periodicity of reporting for inter-UE coordination during operation in the energy mode.

18. The method of claim 1, further comprising transmitting an indication of a periodicity of reporting for inter-UE coordination during operation in the energy mode.

19. The method of claim 1, wherein the configuration indicates a reference signal received power (RSRP) threshold for inter-UE coordination during operation in the energy mode.

20. The method of claim 1, wherein the configuration indicates a set of resources of a resource pool assigned to the UE during operation in the energy mode.

21. The method of claim 1, wherein the configuration indicates a synchronization signal transmission periodicity during operation in the energy mode.

22. A method of wireless communication performed by a network entity, comprising:
receiving an indication of an energy mode in which a user equipment (UE) is to operate,
wherein the energy mode indicates a type of energy harvesting to be performed by the UE and a level of engagement of the UE in association with performing the type of energy harvesting, and
wherein the energy mode is one of a plurality of energy modes associated with a class of the UE; and
operating according to a configuration associated with the energy mode based at least in part on receiving the indication of the energy mode.

23. The method of claim 22, wherein operating according to the configuration comprises operating according to the configuration without transmitting an acknowledgment (ACK) of the indication of the energy mode.

24. The method of claim 22, further comprising transmitting an acknowledgment (ACK) of the indication after receiving the indication,
wherein operating according to the configuration comprises operating according to the configuration based at least in part on transmitting the ACK.

25. The method of claim 22, further comprising transmitting, after receiving the indication of the energy mode, control information indicating the configuration,
wherein operating according to the configuration comprises operating according to the configuration indicated by the control information.

26. The method of claim 22, further comprising transmitting the configuration associated with the energy mode.

27. The method of claim 22, further comprising receiving an indication of whether concurrent sidelink and access link operation is supported during operation in the energy mode.

28. The method of claim 22, wherein a characteristic of wake-up signal operation is based at least in part on the energy mode.

29. A user equipment (UE) for wireless communication, comprising:
a memory; and
one or more processors, coupled to the memory, configured to:
transmit an indication of an energy mode in which the UE is to operate,
wherein the energy mode indicates a type of energy harvesting to be performed by the UE and a level of engagement of the UE in association with performing the type of energy harvesting, and
wherein the energy mode is one of a plurality of energy modes associated with a class of the UE; and
operate according to a configuration associated with the energy mode based at least in part on transmitting the indication of the energy mode.

30. A network entity for wireless communication, comprising:
a memory; and
one or more processors, coupled to the memory, configured to:
receive an indication of an energy mode in which a user equipment (UE) is to operate,
wherein the energy mode indicates a type of energy harvesting to be performed by the UE and a level of engagement of the UE in association with performing the type of energy harvesting, and
wherein the energy mode is one of a plurality of energy modes associated with a class of the UE; and
operate according to a configuration associated with the energy mode based at least in part on receiving the indication of the energy mode.
